(19) United States
(12) Patent Application Publication
(10) Pub. No.: US 2006/0226241 A1
(43) Pub. Date: Oct. 12, 2006

(54) Miniature flash memory card with mini-SD and RS-MMC compatibility

(76) Inventor: Sheng-Chih Hsu, Taipei (TW)

Correspondence Address: LIN & ASSOCIATES INTELLECTUAL PROPERTY, P.O. BOX 2339, SARATOGA, CA, 95070-0339, US

(21) Appl. No.: 11/101,922

(22) Filed: Apr. 8, 2005

(51) Int. Cl. G06K 19/06

(52) U.S. Cl. 235/492

(57) ABSTRACT

Miniature flash memory card with mini-SD and RS-MMC compatibility is provided. This is accomplished by a special circuit layout of the module substrate, so that the memory controller is attached on the front end of the module substrate, and two or more memory dies can be fitted in the memory block toward the back end of the module substrate, using smaller and higher density memory, whereas the conventional memory card has to use monolithic memory module. In the present design, the memory ICs are built into the memory module, but the memory can be easily replaced or added for memory expansion.

### BACKGROUND OF THE INVENTION

1. Field of the Invention

The present invention relates to a miniature flash memory card with mini-SD and RS-MMC compatibility, and in particular to a special circuit layout for the memory module of the flash memory card that allows two or more memory dies to be packaged into the memory block using smaller and higher density memory.

2. The Related Art

The rapid advancement of the digital technology has brought about a new generation of digital devices such as digital still cameras, digital camcorders, and digital audio devices all using flash memory cards to record their data.

The conventional flash memory cards can be either secure digital (SD) or multi-media card (MMC). The dimensions of the SD card are 32 mm×24 mm×2.1 mm, and the dimensions of the MMC card are 32 mm×24 mm×1.4 mm. Since SD and MMC cards have the same width and length, they may be used interchangeably on most standard digital devices.

However, with the introduction of advanced packaging technology, the miniature flash memory cards such as the miniature SD (mini-SD) and reduced size MMC (RS-MMC) gradually increase in popularity. The mini-SD and RS-MMC are the world's smallest and lightest flash memory cards. The RS-MMC has the same 1.4 mm thickness as the MMC, but is virtually half the original size. The dimensions of RS-MMC are 24 mm×18 mm×1.4 mm, 50% of the original MMC. The dimensions of mini-SD are 21.5 mm×20 mm×1.4 mm, with the card size reduced by 60% and the circuit board by 40%. Therefore, adaptors for the mini-SD and RS-MMC cards are mass produced to allow such cards to be converted for the digital processing equipment that can only accept conventional flash memory cards.

The conventional mini-SD card adaptor as shown in FIG. 1 is comprised of a protective shell 10 and a memory module 20, where the memory module 20 is packaged in a protective shell 10 with the position of the contact strip 201 of the memory module 20 corresponding to the plug-in end 101 of the protective shell 10. The memory module 20 includes a module substrate 21, a memory controller 22, and a memory 23.

On the module substrate 21 of a conventional flash memory card, the rectangular memory die 23 is disposed on the right side of the module substrate 21 longitudinally, occupying a greater half of circuit board running from the front end (near the contact strip 201) to the back end, and the memory controller 22 is attached on the left side of the memory 23.

Under the conventional chip packaging technology, there is only 5 mm x 5 mm free space on the left side of the module substrate 21 after the memory die 23 is attached, which is too small for fitting a standard controller. As a result, the memory controller 22 has to be custom-made to fit in that space, so the costs for the conventional flash memory cards remain high.

From the user's standpoint, the structure of the conventional flash memory card employing monolithic memory module is rather inflexible. The conventional flash memory card will not be able to function if the only memory chip is damaged. Also, the memory capacity of the conventional flash memory card is fixed, as the memory on board cannot be changed.

### SUMMARY OF THE INVENTION

The primary objective of the present invention is to provide a miniature flash memory card with full compatibility with mini-SD and RS-MMC, through a special layout of the circuit board that allows two or more memory dies to be packaged into the memory block on the back end of the module substrate using smaller and higher density memory, whereas the conventional memory card has to use monolithic memory module. In the present design, the memory ICs are built into the memory module, but the memory ICs can be easily replaced or added for fulfilling the needs of memory expansion.

According to the present invention, the flash memory card comprises a protective shell and a memory module, wherein the memory module is formed by a module substrate, a memory controller, and a memory block containing two or more memory dies. The memory controller is attached on the front end of the module substrate, and two memory dies are fit into the memory block on the back end of the module substrate, using smaller and higher density memory.

The present design of the flash memory card is intended to increase the memory capacity of the mini-SD card with low costs, which is accomplished with a special layout of the circuit board for mini-SD, taking advantage of the fact that the length of the memory module is always greater than the width. The special circuit layout that can fit two or more dies in the memory block requires high density chip packaging.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an exploded view of the conventional mini-SD flash memory card;

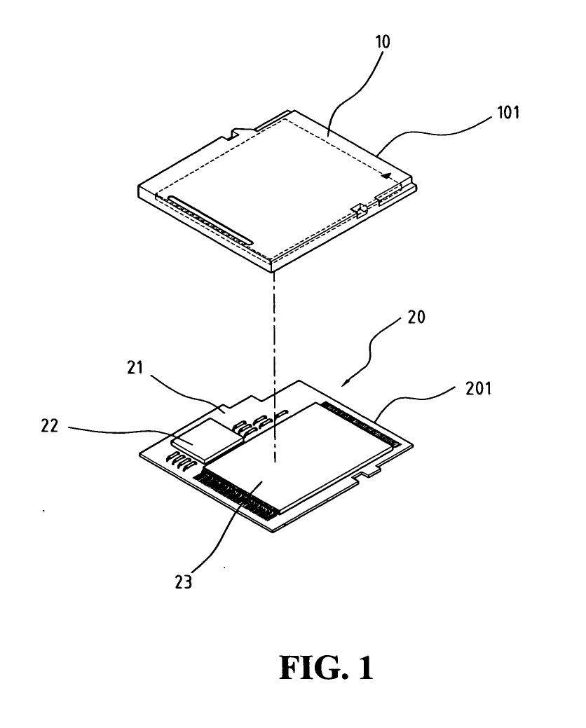

FIG. 2 is an exploded view of the first embodiment of the miniature flash memory card; and

FIG. 3 is an exploded view of the second embodiment of the miniature flash memory card.

### DETAILED DESCRIPTION OF THE PREFERRED EMBODIMENT

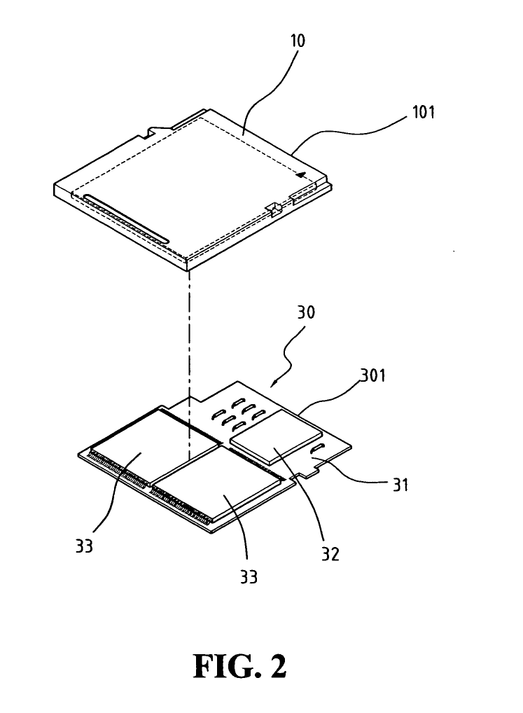

The flash memory card 1, in accordance with the present invention as shown in FIG. 2, comprises a protective shell 10 and a memory module 30, where the memory module 30 is formed by a module substrate 31, a memory controller 32, and a memory block 33 containing two or more memory dies.

The memory module 30 is packaged within the protective shell 10 with the position of the contact strip 301 of the memory module 30 corresponding to the plug-in end 101 of the protective shell 10. The memory ICs are built into the memory module, but the memory ICs can be easily replaced or added.

When the flash memory card 1 is inserted into a card reader with the plug-in end 101 facing the insertion slot of the card reader, data can be read from or written to the memory module bi-directionally, which may be connected with a data processing device or a hand-held digital device.

The module substrate 31 is actually a mini-SD circuit board, which allows two memory dies to be attached onto the memory block 33 occupying the back end of the mini-SD circuit board. The memory dies may be attached onto the module substrate 31 using very-very thin small outline package (WSOP). The memory block containing multiple dies occupies a greater half of circuit board toward the back end, and leaving only a narrow gap around the perimeter of the module substrate 31 for the border area. There is another packaging gap between the memory controller and the memory block 33.

Referring to the first embodiment of the flash memory card as shown in FIG. 2, the memory controller 32 is attached on the front end of the memory module 30 near the contact strip 301, and the memory block 33 is located toward the back end of the module substrate 31 The memory block 33 contains two square-shaped memory dies disposed side by side with 0.1 mm packaging gap reserved in between the two memory dies, together occupying a greater half of the substrate 31 on the back end.

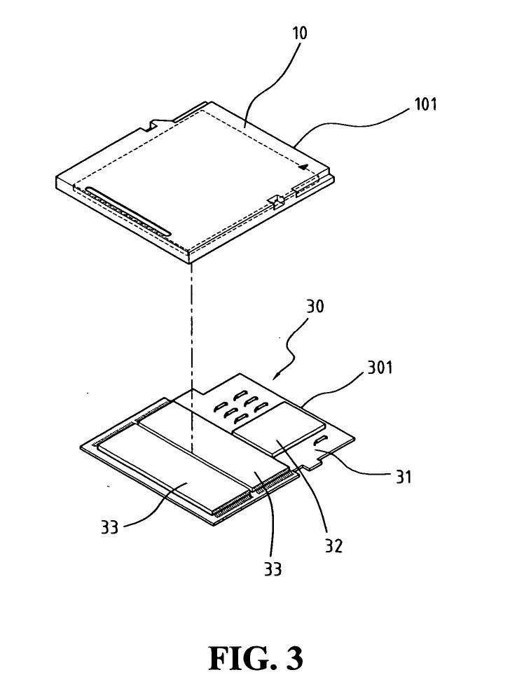

Referring to the second embodiment of the flash memory card as shown in FIG. 3, the memory controller 32 is attached on the front end of the memory module 30 near the contact strip 301, and the memory block 33 is located on the back end of the module substrate 31, which contains two rectangular memory dies placed next to each other in the transversal orientation, with 0.1 mm packaging gap reserved in between the two memory dies.

The special circuit layout takes advantage of the fact that the length of the module substrate is always greater than the width. For example, the mini-SD card with the dimensions 21.5 mm×20 mm×1.4 mm, has the length (21.5 mm) greater than the width (20 mm), so the memory block 33 is arranged on the back end of the module substrate 33. After the memory dies are inserted into the memory block 33, and a gap of predetermined width is reserved between the memory controller 32 and the memory block 33, there is a 7 mm×7 mm free space on the front end of the module substrate for fitting a standard controller 32.

To achieve high density packaging, the memory controller 32 can be attached using the ball grid array (BGA), or land grid array (LGA), or any other packaging method with concealed bonding wires. The Thin Small Outline Package (TSOP) with exposed lead wires is not suitable for mounting the memory controller within the narrow space.

If the BGA method is used, a plurality of solder balls are first placed on the mating surface in a grid format, and then the memory dies are placed over the solder balls to create electrical links with the circuit board in the memory packaging. This method does not involve lead wires.

The land grid array (LGA) method can also be used, which permits electrical connection between a module substrate and a circuit board through a conductive interposer. Connection is achieved by aligning the contact array on the two mating surfaces and the interposer, and mechanically compressing the interposer when the memory dies are attached onto the circuit board.

According to the present design, the present design can be used to produce memory modules 30 containing two or more smaller memory ICs in the memory block, so that the capacity of the memory module can be doubled or tripled. Further, the flash memory card with such memory architecture can improve the fault tolerance of the memory card as well.

The present design is equally applicable on RS-MMC flash memory card, as the structure of the substrate for RS-MMC is very similar to the mini-SD. The memory block of the miniature flash memory card can easily accommodate two or more memory dies with high-density chip packaging, so the memory can be easily added or replaced for the purpose of memory expansion, whereas the conventional flash memory card only accepts the monolithic memory module. Therefore, the present invention has provided a miniature flash memory card with obvious competitive advantage over the conventional flash memory card.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A miniature flash memory card compatible with mini-SD comprising:
a protective shell; and
a memory module, which is formed by a module substrate, a memory controller, and a memory block containing two or more memory dies, wherein the memory controller is attached on the front end of the module substrate, and the memory block with two memory dies is located toward the back end.

2. The miniature flash memory card as claimed in claim 1, wherein module substrate has enough space to fit the standard controller with available space of 7 mm×7 mm after the memory dies are attached.

3. The miniature flash memory card as claimed in claim 1, wherein the memory block contains two memory dies.

4. The miniature flash memory card as claimed in claim 3, wherein the two memory dies are square shaped and arranged side by side occupying the back end of the module substrate.

5. The miniature flash memory card as claimed in claim 3, wherein the two memory dies are rectangular shaped and disposed in transversal orientation occupying the back end of the module substrate.
